(19) United States
(12) Patent Application Publication
(10) Pub. No.: US 2007/0292688 A1
(43) Pub. Date: Dec. 20, 2007

(54) Silylamine modified nanoparticulate carriers

(75) Inventors: Joseph F. Bringley, Rochester, NY (US); Tiecheng A. Qiao, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/206,362

(22) Filed: Aug. 18, 2005

(51) Int. Cl. B32B 5/16; B32B 15/02

(52) U.S. Cl. 428/403; 428/405

(57) ABSTRACT

A composition comprising a colloid that is stable under physiological pH and ionic strength is disclosed. The colloid comprises particles having a core and a shell: a) wherein said shell comprises a silylamine coupling agent; b) wherein the particles have a volume-weighted mean particle size diameter of less than 200 nm, and c) wherein greater than 35% of said silylamine coupling agent present in the colloid is bound to the core surfaces. These core-shell nanoparticulate materials are capable of carrying biological, pharmaceutical or diagnostic components. The components, which might include drugs, therapeutics, diagnostics, and targeting moieties can then be delivered directly to diseased tissue or bones and be released in close proximity to the disease and reduce the risk of side effects to the patient.

### FIELD OF THE INVENTION

The invention relates to colloids containing silylamine-modified nanoparticle carrier particles. More particularly, there are described colloids containing core-shell nanoparticulate carrier particles wherein the shell contains a silylamine functionality. The described carrier particles are stable under physiological conditions.

### BACKGROUND OF THE INVENTION

The ordered assembly of nanoscale and molecular components has promise to create molecular-assemblies capable of mimicking biological function, and capable of interacting with living cells and cellular components. Many techniques for creating nanoscale assemblies are being developed and include small-molecule assembly, polyelectrolyte assembly, nanoscale precipitation, core-shell assemblies, heterogeneous precipitation, and many others. However, a significant challenge lies in creating methods for assembling or fashioning nanoparticles, or molecules, into materials capable of being fabricated into free-standing, stable, working “devices”. Nanoscale assemblies often suffer from instabilities, and resist integration into working systems. A simple example involves integration of nanoscale assemblies into living organisms. Successful integration requires assemblies which are colloidally stable under highly specific conditions (physiological pH and ionic strength), are compatible with blood components, are capable of avoiding detection by the immune system, and may survive the multiple filtration and waste removal systems inherent to living organisms. Highly precise methods of assembly are necessary for building ordered nanoscale assemblies capable of performing under stringent conditions.

More recently, there has been intense interest focused upon developing surface-modified nanoparticulate materials that are capable of carrying biological, pharmaceutical or diagnostic components. The components, which might include drugs, therapeutics, diagnostics, and targeting moieties can then be delivered directly to diseased tissue or bones and be released in close proximity to the disease and reduce the risk of side effects to the patient. This approach has promised to significantly improve the treatment of cancers and other life threatening diseases and may revolutionize their clinical diagnosis and treatment. The components that may be carried by the nanoparticles can be attached to the nanoparticle by well-known bio-conjugation techniques; discussed at length in Bioconjugate Techniques, G. T. Hermanson, Academic Press, San Diego, Calif. (1996). The most common bio-conjugation technique involves conjugation, or linking, to an amine functionality.

U.S. patent application 2003/0206859 Al to Chen et al., assigned to the Trustees of the University of Pennsylvania, describes colloidal dispersions of “amine-terminated” silica particles having a narrowly controlled size range in an aqueous phase for use in diagnostic imaging, drug-delivery, etc. In '859 paragraph [0038], 2.0 mL (or 1.90 g) of a silane coupling agent are added to 50.0 mL of a silica dispersion that contains 0.61 g of silica. The ratio of silane coupling agent (silylamine) to silica is therefore 1.90:0.61 or about 3 to 1. We have discovered that this is a very large excess of that necessary to form a monolayer at the surface of the silica particles. In Chen's composition, only a very small fraction, less than about 10%, of active silane coupling agents in the dispersion are actually bound to the surfaces of the silica particles. The silane coupling agent not adsorbed to the particle surfaces (free amine coupling agent) may interfere with subsequent attachment or conjugation, of biological, pharmaceutical or diagnostic components, since the diagnostic or therapeutic agents may couple to the “free” amines and not be associated with the particles.

It would be desirable to produce nanoparticle carriers for bioconjugation and targeted delivery that are stable colloids so that they can be injected in vivo, especially intravascularly. Further, it is desirable that the nanoparticle carriers be stable under physiological conditions (pH 7.4 and 137 mM NaCl). Still further, it is desirable that the particles avoid detection by the immune system. It is desirable to minimize the number of amine groups not adsorbed to the nanoparticle and limit “free” amine-functionalities in solution, since the free amines may interfere with the function of the nanoparticle assembly.

### PROBLEM TO BE SOLVED BY THE INVENTION

There remains a need for colloids comprising core-shell carrier particles that are stable over useful periods of time, that are stable in physiological conditions, and that may be pH adjusted to effect the bioconjugation of biological, pharmaceutical or diagnostic components. There remains a need for colloids comprising core-shell carrier particles that limit, or minimize, the number of “free” amine functionalities in solution while maintaining colloid stability under physiological conditions, and that preferably use only one, or a few, molecular layers of polymer having amine functionalities in the shell. There remains a need for methods for manufacturing colloids comprising core-shell carrier particles that provide stable colloids having high concentrations (5-50% solids). There is a further need for such colloids that can be made at high production rates and low cost. There is a further need for improved methods of obtaining well-ordered, homogeneous colloids comprising core-shell carrier particles in which substantially all of the carrier particles in the colloid are surface-modified with a silylamine coupling agent, and the colloid is substantially free of unmodified colloid particles, and is substantially free of amine functionalities that are unattached to the colloids. Colloids in which the pH can be freely adjusted between about pH 5 to pH 9 without desorption of the amine functionalities in the shell are also desired.

### DETAILED DESCRIPTION OF THE INVENTION

The invention provides a composition comprising a colloid that is stable under physiological pH and ionic strength, said colloid comprising particles having a core and a shell:

a) wherein said shell comprises a silylamine coupling agent;

b) wherein the particles have a volume-weighted mean particle size diameter of less than 200 nm, and

c) wherein greater than 35% of said silylamine coupling agent present in the colloid is bound to the core surfaces.

The described composition is a stable colloid (sometimes also referred to as a suspension or dispersion). A colloid consists of a mixture of small solid particulates in a liquid, such as water. The colloid is said to be stable if the solid particulates do not aggregate (as determined by particle size measurement) and settle from the colloid, usually for a period of hours, preferably weeks to months. Terms describing colloidal instability include aggregation, agglomeration, flocculation, gelation and settling. Significant growth of mean particle size to diameters greater than about three times the core diameter, and visible settling of the colloid within one day of its preparation is indicative of an unstable colloid.

It is often the surface properties of the particles in the colloid, such as their electrostatic charge, which contributes to the stability of the colloid. Typically the surfaces are significantly charged, positive or negative, so as to provide electrostatic repulsion to overcome forces which would otherwise lead to the aggregation and settling of the particles from the colloid. It has been of interest to surface-modify particles, or to “assemble” colloidal particles of opposite charge to achieve specific properties. However, this is often difficult since the surface modification or assembly disrupts the electrostatic and steric forces necessary for colloidal stability; and stable colloids are not easily obtained. The composition is a stable colloid and hence should remain in suspension for a period of greater than a few hours, and more preferably greater than a few days; and most preferably greater than a few weeks. The zeta potential of the colloid can have a maximum value greater than about ±20 mV, and more preferably greater than about ±30 mV. A high zeta potential is preferred because it increases the colloidal stability of the colloid. The pH of the dispersion may be adjusted as is necessary to obtain a stable colloid during the process steps necessary to produce the final composition. The pH of the colloid can be between about pH 4 and pH 10 and more preferably between about pH 5 and pH 9 during these process steps. In final form, the colloid is stable under physiological conditions (e.g. pH 7.4, 137 mM NaCl), or in buffers or saline solutions typically used in in-vivo applications, especially in compositions used for intravascular injections. Thus, the colloid can remain stable when introduced into, or diluted by, such solutions. Physiological pH and ionic strength may vary from about pH 6 to about pH 8, and salt concentrations of about 30 mM to about 600 mM and the described compositions are stable under any combination within these ranges.

The described composition comprises a colloid including core-shell particles that can serve as carrier particles. These core-shell particles have a mean particle size diameter of less than 200 nm. (For convenience, these particles will be referred to as “nanoparticles” or “nanoparticulates” or similar terms.) The “carrier particles” are those particles including the core and the silylamine coupling agent. This core-shell sub assembly can be the starting point for other assembled particles including additional components such as biological, pharmaceutical or diagnostic components as well as components to improve biocompatibility and targeting, for example. These additional components can make the resulting particles larger.

The particle size(s) of the core-shell particles in the colloid may be characterized by a number of methods, or combination of methods, including coulter methods, light-scattering methods, sedimentation methods, optical microscopy and electron microscopy. The particles in the examples were characterized using light-scattering methods. Light-scattering methods may sample 10⁹ or more particles and are capable of giving excellent colloidal particle statistics. Light-scattering methods may be used to give the percentage of particles existing within a given interval of diameter or size, for example, 90% of the particles are below a given value. Light-scattering methods can be used to obtain information regarding mean particle size diameter, the mean number distribution of particles, the mean volume distribution of particles, standard deviation of the distribution(s) and the distribution width for nanoparticulate particles. In the present core-shell particles, which can be used as carrier particles, it is preferred that at least 90% of the particles be less than 4-times the mean particle size diameter, and more preferably that at least 90% of the particles are less than 3-times the mean particle size diameter. The mean particle size diameter may be determined as the number weighted (mean size of the total number of particles) or as the area, volume or mass weighted mean. It is preferred that the volume or mass weighted mean particle size diameter be determined, since larger particles having a much greater mass are more prominently counted using this technique. In addition, a narrow size-frequency distribution for the particles may be obtained. A measure of the volume-weighted size-frequency distribution is given by the standard deviation (sigma) of the measured particle sizes. It is preferred that the standard deviation of the volume-weighted mean particle size diameter distribution is less than the mean particle size diameter, and more preferably less than one-half of the mean particle size diameter. This describes a particle size distribution that is desirable for injectable compositions.

The core particle can have a negative surface charge. The surface charge of a colloid may be calculated from the electrophoretic mobility and is described by the zeta potential. Colloids with a negative surface charge have a negative zeta potential; whereas colloids with a positive surface charge have a positive zeta potential. It is preferred that the absolute value of the zeta potential of the core-particle be greater than 10 mV and more preferably greater than 20 mV. It is further preferred that the core particle have a negative zeta potential. Measurement of the electrophoretic mobility and zeta potential is described in “The Chemistry of Silica”, R. K. Iler, John Wiley and Sons (1979).

Core particle materials may be selected from inorganic materials such as metal oxides, metal oxyhydroxides and insoluble salts. Preferred core particle materials are inorganic colloidal particles, such as alumina, silica, boehmite, zinc oxide, calcium carbonate, titanium dioxide, and zirconia. In a particularly preferred embodiment the core particles are silica particles. In a particularly preferred embodiment the core particles are silica particles having a diameter between about 4 and 50 nm.

The core particles can have an encapsulated, near-infrared emitting, dye or pigment. Near-infrared emitting dyes or pigments have been used in the optical imaging of live tissues because near-infrared wavelengths have greater light transmission than ultraviolet, visible, or infrared wavelengths. Near-infrared emitting dyes or pigments generally exhibit emission in the wavelength region from about 600-1500 nm. Near infrared emitting dyes or pigments can be selected from but not limited to, near-infrared fluorophores such as cy7, cy5, cy5.5, indocyanine green, Lajolla blue, IRD41, IRD700, NIR-1 and Alexafluor dyes. These dyes and others are discussed at length in published US2003/0044353 A1. These same dyes and pigments can also be used in the shell of the particle as described below.

The shell materials that are useful are referred to herein as “silylamine” coupling agents. Such materials are often generally referred to as “silane” coupling agents or sometimes “organosilane” coupling agents but which, in this case, specifically have an amine functionality.

Shell materials useful in the invention are silylamine or hydrolysable silylamines described by the general formula:
Si(OR)ₐZ_{b}
wherein

R is hydrogen, or a substituted or unsubstituted alkyl group having from 1 to about 20 carbon atoms or a substituted or unsubstituted aryl group having from about 6 to about 20 carbon atoms;

Z is an organic group having from 1 to about 20 carbon atoms or aryl group having from about 6 to about 20 carbon atoms, with at least one of said Z's having at least one primary, secondary, or tertiary nitrogen atom;

a is an integer from 1 to 3; and

b is an integer from 1 to 3;

with the proviso that a+b=4.

It is preferred that that the silylamine coupling agent contain at least one hydrolysable substituent such as a hydroxy, methoxy, ethoxy, propoxy, or butoxy group. The hydrolysable substituent may also be an inorganic group such as Cl, Br or I, which is converted to a compound of the above formula when it is placed in water. The hydrolysable substituent attaches the silylamine coupling agent to the core particle surface via a hydrolysis reaction with the surface of the particles. In a preferred embodiment of the invention the silylamine coupling agent contains at least one non-hydrolysable substituent having at least one nitrogen atom. In a particularly preferred embodiment of the invention the nitrogen atom is a primary, secondary or tertiary amine or amide. Silylamine and hydrolysable silylamine coupling agents useful for the invention include, 3-aminopropyltrimethoxysilane, 3-aminopropyltriethoxysilane, 3-aminopropyldimethylmethoxysilane, N-(2-aminoethyl)-3-aminopropylmethyldimethoxysi lane, 1 ,4-bis[3-(trimethoxysilyl)propyl]ethlenediamine, bis(2-hydroxyethyl)-3-aminopropyltriethoxysi lane, 1-(3-trimethoxysilyl)-propyl urea, (N,N-diethyl-3-amino-propyl)trimethoxysilane and (3-trimethoxysilylpropyl)diethylenetriamine.

Silylamine coupling agents that are useful are commercially available such as from Gelest Inc.; United Chemical Technologies; Aldrich Chemical Co. and others.

Greater than 35% of the silylamine coupling agent having amine functionalities that is present in solution is directly adsorbed to the core particle surfaces, more preferably greater than 70%. This percentage is the weight percentage of silylamine coupling agent directly bonded to the core particles, divided by the total amount of silylamine coupling agent in the colloid. It is desired to minimize the number of amine groups not adsorbed to the nanoparticle and limit “free” amine-functionalities in solution, since the free amines might interfere with the function of the nanoparticle assembly, particularly during subsequent conjugation steps. The amount of silylamine coupling agent adsorbed or bound to the core particle surfaces can be measured by solution state nuclear magnetic resonance (NMR) as described in the experimental section.

If the nanoparticle core-shell particle comprises a cytotoxic component such as metal, metal oxide, or an organic compound, it is desirable to assure biocompatibility between the nanoparticle and a subject to which the nanoparticle may be administered. Some components are relatively inert and less physiologically intrusive than others. Coating or otherwise wholly or partly covering the core-shell nanoparticle carrier with a biocompatible substance can minimize the detrimental effects of any metal organic or polymeric materials.

Biocompatible means that a composition does not disrupt the normal function of the bio-system into which it is introduced. Typically, a biocompatible composition will be compatible with blood and does not otherwise cause an adverse reaction in the body. For example, to be biocompatible, the material should not be toxic, immunogenic or thrombogenic. Biodegradable means that the material can be degraded either enzymatically or hydrolytically under physiological conditions to smaller molecules that can be eliminated from the body through normal processes.

To render biocompatibility of the described core-shell nanoparticle colloid so that it has a suitably long in-vivo persistence (half-life), a protective chain can be added to the surface of the nanoparticle in some embodiments by association with at least some of the amine functionalities. The protective chain can either be a part of the shell or attached to the described to form a second shell. Examples of useful protective chains include polyethylene glycol (PEG), methoxypolyethylene glycol (MPEG), methoxypolypropylene glycol, polyethylene glycol-diacid, polyethylene glycol monoamine, MPEG monoamine, MPEG hydrazide, and MPEG imidazole. The protective chain can also be a block-copolymer of PEG and a different polymer such as a polypeptide, polysaccharide, polyamidoamine, polyethyleneamine, polynucleotide, proteins (such as BSA), lipids (including membrane envelopes) and carbohydrates. Synthetic, biocompatible polymers are discussed generally in Holland et al., 1992, “Biodegradable Polymers”, Advances in Pharmaceutical Sciences 6:101-164.

Addition of these biocompatibility compounds can be performed following the addition of the other biological, pharmaceutical or diagnostic components and can serve as the final synthetic step before introduction of the assembly to a subject or system.

These materials can also be protective or masking agents for the nanoparticle carrier and the biological, pharmaceutical or diagnostic components attached thereto to prevent recognition by the immune system or other biological systems (e.g. proteases, nucleases (e.g. DNAse or RNAse), or other enzymes or biological entities associated with undesired degradation). Thus, the protective addition to the polymer shell provides cloaking or stealth features to facilitate that the assembly reaches a desired cell or tissue with the biological, pharmaceutical or diagnostic component intact.

The present core-shell nanoparticle compositions can be useful as a carrier for carrying a biological, pharmaceutical or diagnostic component. Specifically, the nanoparticulate carrier particles do not necessarily encapsulate a specific therapeutic or an imaging component, but rather serve as a carrier for the biological, pharmaceutical or diagnostic components. Biological, pharmaceutical or diagnostic components such as therapeutic agents, diagnostic agents, dyes or radiographic contrast agents, can be associated with the shell or core. The term “diagnostic agent” includes components that can act as contrast agents and thereby produce a detectable indicating signal in the host mammal. The detectable indicating signal may be gamma-emitting, radioactive, echogenic, fluoroscopic or physiological signals, or the like. A fluoroscopic indicating signal may be generated by attaching a dye or fluorophore to the particle carriers. Flourophores are widely used in biological applications and include molecules or materials such as fluoroscein or rhodamine dyes. Also, particularly useful are near infrared fluorophores such as cy7, cy5, cy5.5, indocyanine green, Lajolla blue, IRD41, IRD700, NIR-1 and Alexafluor dyes. These dyes and others are discussed at length in US2003/0044353 A1.

The term biomedical agent as used herein includes biologically active substances which are effective in the treatment of a physiological disorder, pharmaceuticals, enzymes, hormones, steroids, recombinant products and the like. Exemplary therapeutic agents are antibiotics, thrombolytic enzymes such as urokinase or streptokinase, insulin, growth hormone, chemotherapeutics such as adriamycin and antiviral agents such as interferon and acyclovir. These therapeutic agents can be associated with the shell or core of the nanoparticle which upon enzymatic degradation, such as by a protease or a hydrolase, the therapeutic agents can be released over a period of time.

The described composition can further comprise a biological, pharmaceutical or diagnostic component that includes a targeting moiety that recognizes the specific target cell. Recognition and binding of a cell surface receptor through a targeting moiety associated with a described nanoparticulate core-shell carrier can be a feature of the described compositions. This feature takes advantage of the understanding that a cell surface binding event is often the initiating step in a cellular cascade leading to a range of events, notably receptor-mediated endocytosis. The term “receptor mediated endocytosis” (“RME”) generally describes a mechanism by which, catalyzed by the binding of a ligand to a receptor disposed on the surface of a cell, a receptor-bound ligand is internalized within a cell. Many proteins and other structures enter cells via receptor mediated endocytosis, including insulin, epidermal growth factor, growth hormone, thyroid stimulating hormone, nerve growth factor, calcitonin, glucagon and many others.

Receptor Mediated Endocytosis (hereinafter “RME”) affords a convenient mechanism for transporting a described nanoparticle, possibly containing other biological, pharmaceutical or diagnostic components, to the interior of a cell.

In RME, the binding of a ligand by a receptor disposed on the surface of a cell can initiate an intracellular signal, which can include an endocytosis response. Thus, a nanoparticulate core-shell carrier with a targeting moiety associated, can bind on the surface of a cell and subsequently be invaginated and internalized within the cell. A representative, but non-limiting, list of moieties that can be employed as targeting agents useful with the present compositions is selected from the group consisting of proteins, peptides, aptomers, small organic molecules, toxins, diptheria toxin, pseudomonas toxin, cholera toxin, ricin, concanavalin A, Rous sarcoma virus, Semliki forest virus, vesicular stomatitis virus, adenovirus, transferrin, low density lipoprotein, transcobalamin, yolk proteins, epidermal growth factor, growth hormone, thyroid stimulating hormone, nerve growth factor, calcitonin, glucagon, prolactin, luteinizing hormone, thyroid hormone, platelet derived growth factor, interferon, catecholamines, peptidomimetrics, glycolipids, glycoproteins and polysacchorides. Homologs or fragments of the presented moieties can also be employed. These targeting moieties can be associated with a nanoparticulate core-shell and be used to direct the nanoparticle to a target cell, where it can subsequently be internalized. There is no requirement that the entire moiety be used as a targeting moiety. Smaller fragments of these moieties known to interact with a specific receptor or other structure can also be used as a targeting moiety.

An antibody or an antibody fragment represents a class of most universally used targeting moiety that can be utilized to enhance the uptake of nanoparticles into a cell. Antibodies may be prepared by any of a variety of techniques known to those of ordinary skill in the art. See, e.g., Harlow and Lane, Antibodies: A Laboratory Manual , Cold Spring Harbor Laboratory, 1988. Antibodies can be produced by cell culture techniques, including the generation of monoclonal antibodies or via transfection of antibody genes into suitable bacterial or mammalian cell hosts, in order to allow for the production of recombinant antibodies. In one technique, an immunogen comprising the polypeptide is initially injected into any of a wide variety of mammals (e.g., mice, rats, rabbits, sheep or goats). A superior immune response may be elicited if the polypeptide is joined to a carrier protein, such as bovine serum albumin or keyhole limpet hemocyanin. The immunogen is injected into the animal host, preferably according to a predetermined schedule incorporating one or more booster immunizations, and the animals are bled periodically. Polyclonal antibodies specific for the polypeptide may then be purified from such antisera by, for example, affinity chromatography using the polypeptide coupled to a suitable solid support.

Monoclonal antibodies specific for an antigenic polypeptide of interest may be prepared, for example, using the technique of Kohler and Milstein, Eur. J. Immunol . 6:511-519, 1976, and improvements thereto.

Monoclonal antibodies may be isolated from the supernatants of growing hybridoma colonies. In addition, various techniques may be employed to enhance the yield, such as injection of the hybridoma cell line into the peritoneal cavity of a suitable vertebrate, host, such as a mouse. Monoclonal antibodies may then be harvested from the ascites fluid or the blood. Contaminants may be removed from the antibodies by conventional techniques, such as chromatography, gel filtration, precipitation, and extraction. The polypeptides of this invention may be used in the purification process in, for example, an affinity chromatography step.

A number of “humanized” antibody molecules comprising an antigen- binding site derived from a non-human immunoglobulin have been described (Winter et al. (1991) Nature 349:293-299; Lobuglio et al. (1989) Proc. Nat. Acad. Sci. USA 86:4220-4224. These “humanized” molecules are designed to minimize unwanted immunological response toward rodent antihuman antibody molecules that limits the duration and effectiveness of therapeutic applications of those moieties in human recipients.

Vitamins and other essential minerals and nutrients can be utilized as targeting moiety to enhance the uptake of nanoparticle by a cell. In particular, a vitamin ligand can be selected from the group consisting of folate, folate receptor-binding analogs of folate, and other folate receptor-binding ligands, biotin, biotin receptor-binding analogs of biotin and other biotin receptor-binding ligands, riboflavin, riboflavin receptor-binding analogs of riboflavin and other riboflavin receptor-binding ligands, and thiamin, thiamin receptor-binding analogs of thiamin and other thiamin receptor-binding ligands. Additional nutrients believed to trigger receptor mediated endocytosis, and thus also having application in accordance with the presently disclosed method, are carnitine, inositol, lipoic acid, niacin, pantothenic acid, pyridoxal, and ascorbic acid, and the lipid soluble vitamins A, D, E and K. Furthermore, any of the “immunoliposomes” (liposomes having an antibody linked to the surface of the liposome) described in the prior art are suitable for use with the described compositions.

Since not all natural cell membranes possess biologically active biotin or folate receptors, use of the described compositions in-vitro on a particular cell line can involve altering or otherwise modifying that cell line first to ensure the presence of biologically active biotin or folate receptors. Thus, the number of biotin or folate receptors on a cell membrane can be increased by growing a cell line on biotin or folate deficient substrates to promote biotin and folate receptor production, or by expression of an inserted foreign gene for the protein or apoprotein corresponding to the biotin or folate receptor.

RME is not the exclusive method by which the described core-shell nanoparticles can be translocated into a cell. Other methods of uptake that can be exploited by attaching the appropriate entity to a nanoparticle include the advantageous use of membrane pores. Phagocytotic and pinocytotic mechanisms also offer advantageous mechanisms by which a nanoparticle can be internalized inside a cell.

The recognition moiety can further comprise a sequence that is subject to enzymatic or electrochemical cleavage. The recognition moiety can thus comprise a sequence that is susceptible to cleavage by enzymes present at various locations inside a cell, such as proteases or restriction endonucleases (e.g. DNAse or RNAse).

A cell surface recognition sequence is not a requirement. Thus, although a cell surface receptor targeting moiety can be useful for targeting a given cell type, or for inducing the association of a described nanoparticle with a cell surface, there is no requirement that a cell surface receptor targeting moiety be present on the surface of a nanoparticle.

To assemble the biological, pharmaceutical or diagnostic components to a described core-shell nanoparticulate carrier, the components can be associated with the nanoparticle carrier through a linkage. By “associated with”, it is meant that the component is carried by the nanoparticle, for example the shell of core-shell nanoparticle. The component can be dissolved and incorporated in the particle non-covalently. A preferred method of associating the component is by covalent bonding through the amine function of the shell.

Generally, any manner of forming a linkage between a biological, pharmaceutical or diagnostic component of interest and a core-shell nanoparticulate carrier can be utilized. This can include covalent, ionic, or hydrogen bonding of the ligand to the exogenous molecule, either directly or indirectly via a linking group. The linkage is typically formed by covalent bonding of the biological, pharmaceutical or diagnostic component to the core-shell nanoparticle carrier through the formation of amide, ester or imino bonds between acid, aldehyde, hydroxy, amino, or hydrazo groups on the respective components of the complex. Art-recognized biologically labile covalent linkages such as imino bonds and so-called “active” esters having the linkage —COOCH, —O—O— or —COOCH are preferred. Hydrogen bonding, e.g., that occurring between complementary strands of nucleic acids, can also be used for linkage formation.

After a sufficiently pure colloid (preferably comprising a core-shell nanoparticulate carrier with a biological, pharmaceutical or diagnostic component) has been prepared, it might be desirable to prepare the nanoparticle in a pharmaceutical composition that can be administered to a subject or sample. Preferred administration techniques include parenteral administration, intravenous administration and infusion directly into any desired target tissue, including but not limited to a solid tumor or other neoplastic tissue. Purification can be achieved by employing a final purification step, which disposes the nanoparticle composition in a medium comprising a suitable pharmaceutical composition. Suitable pharmaceutical compositions generally comprise an amount of the desired nanoparticle with active agent in accordance with the dosage information (which is determined on a case-by-case basis). The described particles are admixed with an acceptable pharmaceutical diluent or excipient, such as a sterile aqueous solution, to give an appropriate final concentration. Such formulations can typically include buffers such as phosphate buffered saline (PBS), or additional additives such as pharmaceutical excipients, stabilizing agents such as BSA or HSA, or salts such as sodium chloride.

For parenteral administration it is generally desirable to further render such compositions pharmaceutically acceptable by insuring their sterility, non-immunogenicity and non-pyrogenicity. Such techniques are generally well known in the art. Moreover, for human administration, preparations should meet sterility, pyrogenicity, general safety and purity standards as required by FDA Office of Biological Standards. When the described nanoparticle composition is being introduced into cells suspended in a cell culture, it is sufficient to incubate the cells together with the nanoparticle in an appropriate growth media, for example Luria broth (LB) or a suitable cell culture medium. Although other introduction methods are possible, these introduction treatments are preferable and can be performed without regard for the entities present on the surface of a nanoparticle carrier.

### EXAMPLES

Silica colloids were purchased from Nalco Chemical Company, for example Nalco® 1130, mean particle diameter of 8 nm, 30% solids, pH=10.0, specific surface area=375 m 2/g; and Nalco® 1140, mean particle diameter of 15 nm, 40% solids, pH =9.7, specific surface area=200 m²/g. All core particles have a negative Zeta potential. Silylamine coupling agents were purchased from Gelest and were 3-aminopropyl(triethoxy)silane, and (3-trimethoxysilylypropyl)diethylenetriamine. NHS-mPEG (Mw=5000 Da) was purchase from Nektar Molecule Engineering (catalog # 2M4M0H01).

PBS (phosphate buffer system) buffer was prepared by dissolving: 137 mM NaCl (8 g), 2.7 mM KCl (0.2 g),10 mM Na₂HPO₄ (1.44 g), 2 mM KH₂PO₄ (0.24 g) in 1.0 L distilled water. Preparation of core particles having encapsulated fluorescent dyes Silica particles were prepared by modification of methods described by Stober (W. Stober, A. Fink and E. Bohn, J. Colloid Interface Sci. 26, 62 (1968); N. A. M. Verhaegh and A. van Blaaderen, Langmuir 10, 1427 (1994)). Tetraethylorthosilane (TEOS) and 3-aminopropyl triethoxysilane were purchased from Sigma Aldrich. Polyethyleneimine was purchased from Aldrich Chemicals and is average MW=10,000 g/mol, 233 monomers/mol polymer. The monomer molecular weight for polyethyleneimine (hereafter “PEI”) was taken to be 43.0 g/mol. BVSM is bis-ethene,1,1′-[methylenebis(sulfonyl)] as was obtained from Eastman Kodak Company. PBS (phosphate buffer system) buffer was prepared by dissolving: 137 mM NaCl (8 g), 2.7 mM KCl (0.2 g),10 mM Na2HPO4 (1.44 g), 2 mM KH2PO4 (0.24 g) in 1.0 L distilled water. Succinimidyl ester of methoxy poly(ethylene)glycol propionic acid, MW=5,000 g/mol (hereafter referred to as mPEG-NHS) was purchased from Nektar Molecule Engineering, catalog number m-spa-5000. Flourescent dyes, fluoroscein 5(6)-isothiocyanate and tetramethylrhodamine-isothiocyanate were purchased from Sigma-Aldrich.

Near infrared fluorophore, CY7, was purchased from Amersham Inc., molecular weight=817 g/mol and had the chemical structure 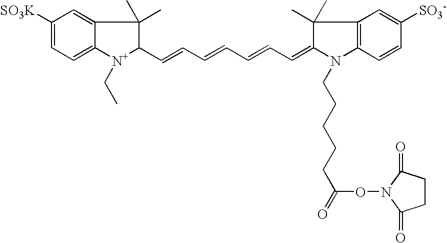
Synthesis of the Near Infrared Fluorescent NIR-2

To a solution of the dye containing the iodide salt of precursor-1 (1.3 g, 2 mmol) in anhydrous pyridine (20 mL) at room temperature were added 1-(3-dimethylaminopropyl)-3-ethylcarbodiimide hydrochloride (0.8 g, 4.1 mmol) and 3-aminopropyl triethoxylsilane (1.32 g, 6 mmol). The resulting mixture was stirred under nitrogen until the starting material was consumed (monitored by TLC). Then the mixture was diluted with anhydrous ether (100 ml), the product was precipitated out as a sticky semisolid material, which was further purified by silica gel chromatograph using (10:1) ethyl acetate/methanol as eluent.

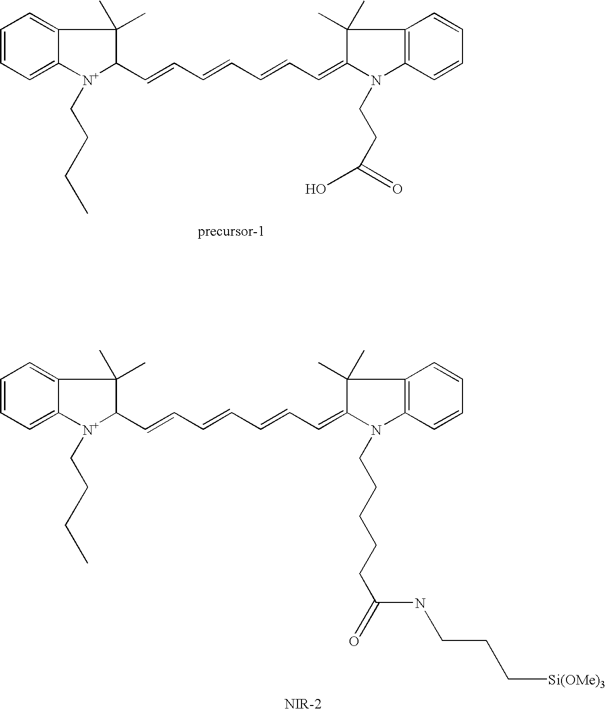

Particle size determination. The volume-weighted, mean particle size diameters of the core-shell nanoparticulate carriers obtained in the following examples were measured by a dynamic light scattering method using a MICROTRAC® Ultrafine Particle Analyzer (UPA) Model 150 from Leeds & Northrop. The analysis provides percentile data that show the percentage of the volume of the particles that is smaller than the indicated size. The 50 percentile is known as the median diameter, which is referred herein as “median particle size diameter”. The “volume-weighted mean particle size diameter” is calculated from the area distribution of the particle size as described in the MICROTRAC® Ultrafine Particle Analyzer (UPA) Model 150 manual. The standard deviation describes the width of the particle size distribution. The smaller the standard deviation the narrower the width of the particle size distribution.

Quantitative determination of silylamine adsorption. Solution state ¹H NMR spectroscopy was used as a quantitative method to determine the amount of silylamine coupling agent adsorbed onto the colloidal nanoparticles. This is possible since it is known that chemical species adsorbed to a particle surface show reduced mobility and are also subject to changes in magnetic susceptibility. Both of these factors lead to substantially increased line-widths of the NMR resonances and result in an inability to observe the resonances for materials associated with (adsorbed or attached to) the surface of the particle. Therefore, the observed NMR resonances arise from only chemical species dissolved in solution. The adsorbed amount is thus obtained indirectly with knowledge of the total amount present. The procedure employs an external reference to compare the signal of the dispersant from sample-to-sample. The reference, 3-(trimethylsilyl)propionic-3,3,2,2-d₄ acid sodium salt (TSP), was placed in a sealed coaxial tube inside the tube containing the sample of interest. The same coaxial reference tube was used for each sample. A control solution containing a known amount of silylamine coupling agent was made in order to calibrate the signal to the coaxial reference. A Varian Inova® NMR spectrometer (Varian Inc., Palo Alto, Calif.) operating at a ¹H frequency of 500 MHz was used to obtain the data. Presaturation was used to reduce the water signal, and a total relaxation delay of 13.5 seconds was used to ensure quantitative conditions. The same experimental parameters were used for all samples. Typically, a ¹H NMR spectrum was obtained in under 5 minutes.

Nanoparticle Carrier Surface Modification:

Comparative examples have the designation “C”. Examples of the invention have the designation “I”.

C-1: Into a 250 mL container was added 100.0 g of a 10% w/w silica colloid prepared by dilution of Nalco® 1140. To the stirred suspension was then added 0.37 g of (3-trimethoxysilylypropyl)diethylenetriamine. The pH of the mixture was then adjusted to about 5.0 through the addition of 1.34 g of a 4.0 N solution of nitric acid. The suspension was then allowed to stir at room temperature for 3 days. The mean particle size diameter, fraction silylamine coupling agent adsorbed to the surfaces of particles and the physical characteristics are given in Table 1.

I-1: Performed in an identical manner to that of C-1 except that 0.77 g of (3-trimethoxysilylypropyl)diethylenetriamine was added in place of the amount in C-1 and the pH of the mixture was adjusted to about 5.0 through the addition of 1.98 g of a 4.0 N solution of nitric acid. The mean particle size diameter, fraction silylamine coupling agent adsorbed to the surfaces of particles and the physical characteristics are given in Table 1.

I-2: Performed in an identical manner to that of C-1 except that 1.19 g of (3-trimethoxysilylypropyl)diethylenetriamine was added in place of the amount in C-1 and the pH of the mixture was adjusted to about 5.0 through the addition of 2.94 g of a 4.0 N solution of nitric acid. The mean particle size diameter, fraction silylamine coupling agent adsorbed to the surfaces of particles and the physical characteristics are given in Table 1.

I-3: Performed in an identical manner to that of C-1 except that 3.01 g of (3-trimethoxysilylypropyl)diethylenetriamine was added in place of the amount in C-1 and the pH of the mixture was adjusted to about 5.0 through the addition of 6.55 g of a 4.0 N solution of nitric acid. The mean particle size diameter, fraction silylamine coupling agent adsorbed to the surfaces of particles and the physical characteristics are given in Table 1.

C-2: Performed in an identical manner to that of C-1 except that 12.05 g of (3-trimethoxysilylypropyl)diethylenetriamine was added in place of the amount in C-1 and the pH of the mixture was adjusted to about 5.0 through the addition of 26.07 g of a 4.0 N solution of nitric acid. The mean particle size diameter, fraction silylamine coupling agent adsorbed to the surfaces of particles and the physical characteristics are given in Table 1.

TABLE 1

| | ratio | | | | |
|---|---|---|---|---|---|
| Ex. or | silylamine: | mean | standard | | |
| Comp. | silica | Particle Size | deviation | Stable | % bound |
| Ex. | w/w | diameter (nm) | (nm) | Colloid | silylamine |
| C-1 | 0.03 | 4,500 | 3,000 | No | 98 |
| I-1 | 0.06 | 123 | 78 | Yes | 85 |
| I-2 | 0.09 | 41 | 13 | Yes | 69 |
| I-3 | 0.20 | 24 | 6 | Yes | 40 |
| C-2 | 0.50 | 27 | 5 | Yes | 11 |
| silica | 0 | 14 | 4 | Yes | n.a. |

n.a. = not applicable

The results of Table 1 indicate that the examples of the invention provide colloidally stable carrier particles having a high fraction, greater than 5 35%, of bound silylamine coupling agent, which occurs only for a narrow range of silylamine to silica ratios, from about 0.04 to about 0.20. Another measure of the coverage of the particle surfaces may be provided by the molar ratio of silylamine coupling agent to silica surface area. The weight ratios above (0.04 to 0.20) correspond to 0.75 to 3.8 μmol silylamine/m² silica surface.

C-3: Into a 250 mL container was added 100.0 g of a 10% w/w silica colloid prepared by dilution of Nalco® 1140. To the stirred suspension was then added 0.25 g of 3-aminopropyl(triethoxy)silane. The pH of the mixture was then adjusted to about 5.0 through the addition of 0.74 g of a 4.0 N solution of nitric acid. The suspension was then allowed to stir at room temperature for 3 days. The mean particle size diameter, fraction silylamine coupling agent adsorbed to the surfaces of particles and the physical characteristics are given in Table 2.

I-4: Performed in an identical manner to that of C-1 except that 0.53 g of 3-aminopropyl(triethoxy)silane was added in place of the amount in C-1 and the pH of the mixture was adjusted to about 5.0 through the addition of 1.05 g of a 4.0 N solution of nitric acid. The mean particle size diameter, fraction silylamine coupling agent adsorbed to the surfaces of particles and the physical characteristics are given in Table 2.

I-5: Performed in an identical manner to that of C-1 except that 0.82 g of 3-aminopropyl(triethoxy)silane was added in place of the amount in C-1 and the pH of the mixture was adjusted to about 5.0 through the addition of 1.31 g of a 4.0 N solution of nitric acid. The mean particle size diameter, fraction silylamine coupling agent adsorbed to the surfaces of particles and the physical characteristics are given in Table 2.

I-6: Performed in an identical manner to that of C-1 except that 2.06 g of 3-aminopropyl(triethoxy)silane was added in place of the amount in C-1 and the pH of the mixture was adjusted to about 5.0 through the addition of 2.85 g of a 4.0 N solution of nitric acid. The mean particle size diameter, fraction silylamine coupling agent adsorbed to the surfaces of particles and the physical characteristics are given in Table 2.

C-4: Performed in an identical manner to that of C-1 except that 8.24 g of 3-aminopropyl(triethoxy)silane was added in place of the amount in C-1 and the pH of the mixture was adjusted to about 5.0 through the addition of 10.52 g of a 4.0 N solution of nitric acid. The mean particle size diameter, fraction silylamine coupling agent adsorbed to the surfaces of particles and the physical characteristics are given in Table 2.

TABLE 2

| | ratio | | | | |
|---|---|---|---|---|---|
| Ex. or | silylamine: | mean | standard | | |
| Comp. | silica | Particle Size | deviation | Stable | % bound |
| Ex. | w/w | diameter (nm) | (nm) | Colloid | silylamine |
| C-3 | 0.025 | 343 | 62 | No | 94 |
| I-4 | 0.053 | 26 | 11 | Yes | 78 |
| I-5 | 0.082 | 44 | 19 | Yes | 68 |
| I-6 | 0.21 | 26 | 4 | Yes | 37 |
| C-4 | 0.824 | 28 | 4 | Yes | 19 |
| silica | 0 | 14 | 4 | Yes | |

The results of Table 2 indicate that the examples of the invention provide colloidally stable carrier particles having a high fraction, greater than 35%, of bound silylamine coupling agent, which occurs only for a narrow range of silylamine to silica ratios, from about 0.04 to about 0.20. Another measure of the coverage of the particle surfaces may be provided by the molar ratio of silylamine coupling agent to silica surface area. The weight ratios above (0.04 to 0.20) correspond to 0.9 to 4.5 μmol silylamine/m² silica surface.

Stabilization in PBS Buffer:

C-5: 10.0 mL of the nanoparticle carrier suspension obtained from C-1 was added slowly with vigorous stirring to 10.0 mL of PBS buffer (pH =7.3). Where necessary the pH of the resulting suspension was adjusted to pH 7.0 with 1.0 N NaOH. The suspension was then allowed to stir at room temperature for 1 day. The mean particle size diameter of the suspension and standard deviation are given in Table 3.

I-7: Performed in an identical manner to that of C-5 except that 10.0 mL of the nanoparticle carrier suspension obtained from I-1 was added slowly with vigorous stirring to 10.0 mL of PBS buffer (pH=7.3). The mean particle size diameter of the suspension and standard deviation are given in Table 3.

I-8: Performed in an identical manner to that of C-5 except that 10.0 mL of the nanoparticle carrier suspension obtained from 1-2 was added slowly with vigorous stirring to 10.0 mL of PBS buffer (pH=7.3). The mean particle size diameter of the suspension and standard deviation are given in Table 3.

I-9: Performed in an identical manner to that of C-5 except that 10.0 mL of the nanoparticle carrier suspension obtained from I-3 was added slowly with vigorous stirring to 10.0 mL of PBS buffer (pH=7.3). The mean particle size diameter of the suspension and standard deviation are given in Table 3.

C-6: Performed in an identical manner to that of C-5 except that 10.0 mL of the nanoparticle carrier suspension obtained from C-2 was added slowly with vigorous stirring to 10.0 mL of PBS buffer (pH=7.3). The mean particle size diameter of the suspension and standard deviation are given in Table 3.

TABLE 3

| | ratio | | | | |
|---|---|---|---|---|---|
| Ex. or | silylamine: | mean | standard | | |
| Comp. | silica | Particle Size | deviation | Stable | % bound |
| Ex. | w/w | diameter (nm) | (nm) | Colloid | silylamine |
| C-5 | 0.03 | 5,242 | 813 | No | 98 |
| I-7 | 0.06 | 385 | 180 | Yes | 85 |
| I-8 | 0.09 | 30 | 12 | Yes | 69 |
| I-9 | 0.20 | 19 | 7 | Yes | 40 |
| C-6 | 0.50 | 24 | 5 | Yes | 11 |

The results of Table 3 indicate that the nanoparticle carriers of the invention may be stabilized at physiological pH and ionic strength (PBS buffer) and have a high fraction of bound silylamine coupling agent, which occurs only for a narrow range of silylamine to silica ratios, from about 0.06 to about 0.20.

Pegylation of Nanoparticles

I-10: Core-shell nanoparticulate carrier from example 2 (I-2) were dialysed overnight against distilled water and diluted with 0.05 M aqueous NaHCO₃ to 0.3% solids. Reaction of the particles with a known concentration of fluoresamine and calibration of the fluorescence against a standard indicated that the particles contained 1020 umol primary amine bound to their surfaces per 1.00 g of silica core particles. To 10.0 mL of the 0.3% aminated core-particle suspension suspension was then added 100 mg of NHS-mPEG (Mw=5000 Da) and the sample was stirred for 2 hours. The mean particle size diameter and the value of the Zeta potential are reported in Table 4.

I-11: Performed in an identical manner to that of I-10 except that 150 mg of NHS-mPEG (Mw=5000 Da) was added. The mean particle size diameter and the value of the Zeta potential are reported in Table 4.

I-12: Performed in an identical manner to that of 1-10 except that 200 mg of NHS-mPEG (Mw=5000 Da) was added. The mean particle size diameter and the value of the Zeta potential are reported in Table 4.

TABLE 4

| | ratio | | | | |
|---|---|---|---|---|---|
| | m-PEG: | | | | |
| Ex. or | primary | mean | Zeta | Zeta | Zeta |
| Comp. | amine | Particle Size | Potential | Potential | Potential |
| Ex. | (mol:mol) | diameter (nm) | pH = 4.0 | pH = 7.0 | pH = 10.0 |
| 1-10 | 0.67 | 67 | 4.7 | 6.2 | 1.2 |
| I-11 | 1.00 | 63 | 4.8 | 1.4 | 0.5 |
| I-12 | 1.33 | 63 | 3.9 | 3.0 | 3.7 |
| un- | 0 | 41 | 37.2 | 13.3 | −22.2 |
| treated | | | | | |
| (I-2) | | | | | |

The data of Table 4 indicate that the core-shell nanoparticulate carriers may be coated with a bio-compatible shell, in this case provided by a poly(ethylene) glycol polymer. The successful coating is confirmed from the particle size distribution data and further from the Zeta potential that shows that the surface charge of the core-shell nanoparticulate carriers becomes independent of pH.

Attachment of Dyes onto Pegylated Nanoparticle Carrier

I-13: Core-shell nanoparticulate carrier from example 2 (I-2) were dialysed overnight against distilled water and diluted with 0.05 M aqueous NaHCO₃ pH 7.4 to 0.3% solids. To 15.0 mL of the 0.3% aminated core-particle suspension suspension was then added 150 mg of NHS-mPEG (Mw=5000 Da) and the sample was stirred for 4 hours at room temperature. 7.5 mL of the reaction mixture was then dialysed against PBS buffer using a 30,000 MWCO filter to remove any unattached m-PEG. To this dialysed sample was then added 0.002 g of CY7-NHS near infrared fluorophore and the suspension stirred at room temperature in the dark for 3 hours. The reaction mixture was then dialysed against PBS buffer using a 30,000 MWCO filter to remove any unattached NHS-CY7 or hydrolysis products thereof. The mean particle size diameter of the suspension was 60 nm. Fluorescence spectroscopy indicated a fluorescence band centered at 785 nm, the excitation wavelength employed was 730 nm.

1. A composition comprising a colloid which is stable under physiological pH and ionic strength, said colloid comprising particles having a core and a shell:
a) wherein said shell comprises a silylamine coupling agent;
b) wherein the particles have a volume-weighted mean particle size diameter of less than 200 nm, and
c) wherein greater than 35% of said silylamine coupling agent present in the colloid is bound to the core surfaces.

2. A composition according to claim 1 wherein said volume-weighted mean particle size diameter is less than 100 nm.

3. A composition according to claim 1 wherein the standard deviation of said volume-weighted mean particle size diameter is less than the mean particle size diameter.

4. A composition according to claim 1 wherein said silylamine coupling agent is selected from:
3-aminopropyltrimethoxysilane, 3-aminopropyltriethoxysilane, 3-aminopropyldimethylmethoxysilane, N-(2-aminoethyl)-3-aminopropylmethyldimethoxysilane, 1,4-bis[3-(trimethoxysilyl )propyl]ethlenediamine, bis(2-hydroxyethyl)-3-aminopropyltriethoxysilane,1-(3-trimethoxysilyl)-propyl urea, (N,N-diethyl-3-amino-ropyl)trimethoxysilane and (3-trimethoxysilylpropyl)diethylenetriamine.

5. A composition according to claim 1 wherein said core is silica.

6. A composition according to claim 5 wherein the core has an encapsulated dye or pigment.

7. A composition according to claim 1 wherein said core has a negative charge.

8. A composition according to claim 1 wherein greater than 70% of said silylamine coupling agent in the colloid is bound to the core surfaces.

9. A composition according to claim 1 wherein a protective chain is on the surface of said particle.

10. A composition according to claim 1 wherein said particles further comprise a biological, pharmaceutical or diagnostic component.

11. A composition according to claim 1 wherein the solids content of said colloid is between about 1 and 30% by weight.

12. A composition according to claim 1 wherein the colloid contains between 0.5 and 5 μmol silylamine/m² core particle surface area.

13. A composition according to claim 1 wherein the colloid contains between 100 and 1000 μmol silylamine/g core particles.

14. A composition according to claim 1 wherein the mean volume-weighted particle size diameter is less than 50 nm.

15. A composition according to claim 1 wherein the colloid is stable between pH 5 and 9.

16. A composition according to claim 1 further comprising a fluorescent material.

17. A composition according to claim 1 wherein the core particles are selected from colloids of SiO₂, TiO₂, Al₂O₃, AlOOH, ZrO₂, or Fe₃O₄.
